(19) United States
(12) Patent Application Publication
(10) Pub. No.: US 2012/0114429 A1
(43) Pub. Date: May 10, 2012

(54) FROZEN BACLFILL MIX FORMULATIONS AND PROCESS FOR USE THEREOF IN UNDERGROUND MINING APPLICATIONS

(75) Inventors: Daniel Leonardo Cluff, Sudbury (CA); Vassilios Kazakidis, Sudbury (CA)

(73) Assignee: LAURENTIAN UNIVERSITY OF SUDBURY, Sudbury, ON (CA)

(21) Appl. No.: 13/319,039

(22) PCT Filed: May 4, 2010
(86) PCT No.: PCT/CA2010/000686

§ 371 Date: Jan. 18, 2012

Related U.S. Application Data
(60) Provisional application No. 61/213,081, filed on May 5, 2009.

(51) Int. Cl. E21F 15/00; E21C 41/16; C04B 14/02; E21F 15/02

(52) U.S. Cl. 405/267; 106/400

(57) ABSTRACT

Formulations are provided for producing structural members or back fill for mine stopes in environments having sub zero temperatures such as permafrost. The formulations having constituents including crushed rock (rockfill), powdered tailings, ice and water in specific ratios with attention to the prescribed gradations of the rockfill and tailings. The tailings, a readily available and very finely divided material, fill the naturally existing voids in the rockfill. The gradation of the rockfill and the bulk density of the rockfill establish the rockfill/tailings ratio, which has been determined to lie between 1 and 3 or from 50/50 to about 75/25 for optimum strength. The ice in the mix design arises from the pre-existing moisture content in the rock and tailings typically 2% to 5% for the rockfill, 8% to 25% for the tailings. The change of state of liquid water to ice on the particle surfaces is the binding mechanism of the system and is enhanced by vigorous mixing.

### RELATED PATENT APPLICATIONS

This patent application claims priority of the U.S. patent application No. 61/213,081 filed on May 5, 2009, the whole content of which is incorporated herein by explicit reference for all intents and purposes.

### FIELD OF THE INVENTION

The present invention relates to frozen backfill mix formulations and process for use thereof in underground mining applications to replace cement based backfill formulations.

### BACKGROUND OF THE INVENTION

Mines located within cold regions may benefit from alternatives to the conventional cemented rockfill, pastefill or hydraulic backfill of open stopes by using a frozen backfill. If the process can be demonstrated to be feasible in terms of the strength and stiffness requirements and is economic compared to the standard methods, then northern mines such as Diavic Mine, Eskay Creek Mine, Polaris Mine and Raglan Mine may benefit from the development of frozen backfill (Archibald and Nantel, 1996; Bandopadhyay and Izaxon, 2004; Dismuke and Diment, 1996; Eigenbrok and Roggensack, 1992; Kenn, 1992).

An environmentally friendly option compared to the use of cementitious products; frozen backfill would be comprised of the waste rock from operations and tailings from the mill placed back into the mine without the use of any extra materials except water. The research and analysis will provide design guidelines for the use of frozen backfill as it relates to the mixing methodology, placement constraints and thermal properties of the backfill material.

An initial concept of frozen fill considered at Raglan Mine (EBA Engineering Consultants Ltd., 1992 and 2005) was to flood waste rockfill with water and freeze in-situ using the ambient permafrost conditions of a stope excavation. The time necessary for natural freezing of the backfill material depends on the quantity of water and the granular composition of the rock. Two or three months are usually necessary for setting up the backfill and freezing layer-by-layer to the point of stability. The practicality and economic feasibility of using active refrigeration delivered to a tailings fill mass through freezing pipes in non-permafrost conditions was demonstrated by Marklund & Andersson, (1998). This was done underground in the context of a sill pillar recovery operation where the cost of freezing closer to the time of pillar recovery was shown to be cost-effective compared to the cost of cementing the fill earlier.

A follow-up study done by Falconbridge (Swan et al, 2003) considered the same technique but for general mining applications. A set of FLAC thermal models were built to investigate the time required to freeze a partially saturated rockfill panel, using vertical freeze pipes, and assuming that the rockfill was placed at different temperatures. The simulation work concluded that it is possible to freeze the fill in place, but the time required to freeze the panel is extremely sensitive to the initial temperature of the partially saturated rockfill. In the case of cut-and-fill stopes and tailings fill, these pipes can be pre-placed as part of the fill pour preparation cycle. In the Raglan blast-hole waste rock scenario, this procedure has practical difficulties, so that the pipes would likely be placed in specially drilled holes after placement of waste in the stope, adding considerably to the cost and risk of potential operational delays.

Patent publication SU1116184 A1 1 VNII Zolota Redkikh Metallov entitled: FILL-UP MIXTURE COMPOSITION is directed to a mixture for filling worked out underground cavities. The mixture contains crushed frozen rock, water, and additional clay sludge and crushed ice to increase strength. The mixture contains (in wt. %): 6-7.5 clay slime, 20-24 crushed ice, 58-62 crushed frozen rock and water 10-12.5. Addition of clay slime and crushed ice to the mixture for filling worked out cavities increases its strength and hardening rate. Tests show that addition of clay slime and crushed ice increases the strength of the hardened mixture by about a factor of two (2) times, to about 36 kg/sq. cm. There is a well known composition of a laying mixture that includes cement, sand, gravel and clay slime.

United States Patent Publication 2006/207946A1 owned by CIBA Spec Chem Water Treat Ltd. Entitled “Treatment of aqueous suspensions” discloses a process in which coarse and fine fractions are used together with a rigidifying amount of an aqueous solution of water-soluble polymer.

U.S. Pat. No. 4,377,353 entitled “Underground Mining And Rock Stabilisation System” discloses a process in which cavities formed during underground mining are refilled with stabilising ice, the walls of the cavities initially being cooled to below 0° C. The water, possibly with reinforcing fibres, is supplied intermittently to the cavity to be frozen in layers, the ice being maintained by removing the inflowing geothermal heat. This type of arrangement is very dangerous to miners as sections may easily collapse.

U.S. Pat. No. 4,940,366 entitled “Method of treating backfill” which discloses a method for preparing excavated soil to render it suitable as hardened backfill by mixing with the soil a cementitious substance and ice particles, the ice particles being used in lieu of the water normally required to react with the cementitious substance. The cementitious constituent is very costly which is a drawback to this type of formulation.

U.S. Pat. No. 3,790,215 entitled “Recovery Of Ores And Minerals While Using Ice As Means Of Support In Mined Rooms” is directed to supporting lateral or hanging rock walls in mines where ice is induced to flow into the mine rooms under a static head into the rooms being worked out for filling the latter, the filling with flowing ice being effected progressively during the primary mining successively to and at the same rate as ore in front of and below the ice is blasted and removed. This is a slow and costly process moving so much ice and having to work around it during mining operations.

Therefore, it would be very useful to provide backfill mix formulations and processes for backfilling stopes in underground mining applications to replace, predominantly, ice and cement-based backfill formulations which are respectively dangerous and expensive.

### SUMMARY OF THE INVENTION

The present invention backfill mix formulations and processes for use thereof in underground mining applications to replace cement-based backfill formulations.

Generally speaking the present invention provides frozen backfill formulations having constituents including rockfill, fine powdered tailings, ice and water in specific ratios with attention to the prescribed gradations of the rockfill and tailings. The tailings, a readily available and very finely divided material, fill the naturally existing voids in the rockfill. The gradation of the rockfill and the bulk density of the rockfill establish the rockfill/tailings ratio, which has been determined to lie between 1 and 3 or from 50/50 to about 75/25 for optimum strength. The ice in the mix design arises from the pre-existing moisture content in the rock and tailings typically 2% to 5% for the rockfill, 15% to 25% for the tailings. Being in a frozen state, the ice has the capacity to offset some of the latent heat contained in the liquid water. When sufficient latent heat has not been removed from the frozen backfill prior to placement, the equilibrium temperature of the frozen backfill is moderated to be at or near zero until the latent heat is exhausted from the frozen backfill. The change of state of liquid water to ice on the particle surfaces is the binding mechanism of the system. Vigorous mixing of the water onto the surfaces of the solid materials i.e., total wetting of the constituents is needed. The mixing in the method disclosed herein may accomplished by a combination of spray jets under sufficient pressure to wet deeply into the materials as they fall freely. Mechanical mixing can be achieved by a gravity-driven baffle system, rotating baffles such as an autogenous grinder or nested conveyance systems.

It is noted that while these formulations have useful utility as back fill formulations in mine stopes located in environments having a year round subzero ground temperature, it will be appreciated that these formulations may be used as structural formulations for rapid construction of structures in these environments, and is not limited to formulations for back filling mine stopes.

Thus, an embodiment of the present invention provides a structural formulation for producing structures in an environment having a year round subzero ground temperature, comprising:

a) crushed rock present in an amount from about 50 wt % to about 75 wt %;

b) powdered tailings present in an amount from about 25 wt % to about 50 wt %;

c) water present in an amount not less than about 5 wt % and not greater than about 9 wt %;

d) ice, a sum of naturally present ice and that due to the addition of liquid water, being present in an amount not greater than 15% including that due to the addition of liquid water; and

e) wherein said structural formulation once frozen exhibits a strength of at least 1 mega Pascal (MPa).

The structural formulation may be used as a back fill formulation for filling mine stopes at a mine located in the environments having a year round subzero ground temperature.

The structural formulation may be used for producing structures in the environments having a year round subzero ground temperature.

The crushed rock includes rocks of a general size in a range from about 50 mm mean diameter to about 1000 mm diameter.

The structural formulation according to claim 1 or 2 wherein said powdered tailings include powder particles of a general size in a range from about 0.001 mm mean diameter to about 1 mm diameter.

The crushed rock may be present in an amount from about 60 wt % to about 65 wt %. The powdered tailings may be present in an amount from about 35 wt % to about 40 wt %.

Preferably the crushed rock originated from waste rock produced from mining operations at the mine and the powdered tailings come from tailings produced from milling operations at the mine.

In another embodiment of the invention there is provided a method of producing a structural member in an environment having year round subzero ground temperature, comprising the steps of:

vigorously mixing together a formulation including crushed rock present in an amount from about 50 wt % to about 75 wt %, powdered tailings present in an amount from about 25 wt % to about 50 wt %, water present in an amount not less than about 5 wt % and not greater than about 9 wt %, and naturally occurring ice, the sum of naturally present ice and that due to the addition of liquid water, being present in an amount not greater than 15% including that due to the addition of liquid water while flowing the mixture into a form work containing the as deposited formulation, the addition of liquid water being by spraying a mass of the crushed rock mixed with the powdered tailings with cold water jets as the mixture is dumped into the form work, wherein said formulation once frozen exhibits a strength of at least 1 mega Pascal (MPa).

A further understanding of the functional and advantageous aspects of the invention can be realized by reference to the following detailed description and drawings.

### BRIEF DESCRIPTION OF THE DRAWINGS

The embodiments of the present invention are described with reference to the attached figures, wherein:

FIG. 1 shows the effect on strength of adding tailings as the total water/ice content increases;

FIG. 2 shows a plot of strength vs. strain for the backfill formulations for the different compositions shown in the legend;

FIG. 3 is a plot of backfill composition vs. uniaxial compressive strength (MPa);

FIG. 4 shows cooling curves obtained on the central axis at the geometrical center and at 20 cm intervals to the upper surface of a cylindrical formation of the backfill composition;

FIG. 5 shows cooling curves obtained along the radial axis at the geometric center and at 7.5 cm intervals to the outer surface on the same cylindrical formation of FIG. 4;

FIG. 6 shows the normalized cooling curve data for the radial measurements of FIG. 5;

FIG. 7 shows a plot of weight % versus mean size showing the upper and lower gradation limits for the preferred mean size of the powdered tailings used in the back fill formulations according to the present invention; and

FIG. 8 shows a plot of weight % versus mean size showing the upper and lower gradation limits for the preferred mean size of the crushed rock used in the back fill formulations according to the present invention.

### DETAILED DESCRIPTION OF THE INVENTION

The systems described herein are directed, in general, to embodiments of frozen backfill mix formulations and process for use thereof in underground mining applications. Although embodiments of the present invention are disclosed herein, the disclosed embodiments are merely exemplary and it should be understood that the invention relates to many alternative forms. Including different shapes and sizes. Furthermore, the Figures are not drawn to scale and some features may be exaggerated or minimized to show details of particular features, while related elements may have been eliminated to prevent obscuring novel aspects.

Therefore, specific structural and functional details disclosed herein are not to be interpreted as limiting but merely as a basis for the claims and as a representative basis for enabling someone skilled in the art to employ the present invention in a variety of manner. For purposes of instruction and not limitation, the illustrated embodiments are all directed to embodiments of frozen backfill mix formulations and process for use thereof in underground mining applications.

As used herein, the term “about”, when used in conjunction with ranges of dimensions of particles, compositions of mixtures or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

The present invention provides backfill mix formulations and processes for use in underground mining applications to replace cement-based backfill formulations. The conventional backfill methods which use cement as a binder are costly and less environmentally suitable than a method that does not involve cement. For operations above the 60° latitude or in any environment involving permafrost or sub-zero temperatures the costs of transporting materials is high with a window of opportunity existing for ground transport while the “ice roads” are available. Otherwise air transport is the option of last resort. A limited number of transport trips are available for materials and a considerable impact on the delivery schedule would be realized by not having to transport of thousands of tonnes of cement per year. As well with the current environmental concerns over atmospherically released carbon, a mining operation could realize significant reductions in their overall carbon footprint by eliminating the cement, transportation thereof and heating required to hydrate the cementitious backfill that would have been used should they embrace Frozen Backfill technology.

For environments above 60° latitude or in any environment involving permafrost or sub-zero temperatures there exists a unique opportunity to use a frozen backfill containing liquid water as the binding agent in a mixture with the waste rock and tailings that are usually byproducts of mining operations. The benefits of using a frozen backfill in lieu of the standard backfill options are immense from an operational, environmental and cost perspective.

In developing the present frozen backfill delivery system attention is given to specific details and controls relating to the differences, predominantly temperature measurement and concentrations of the constituents, in the delivery technology. In the long term, frozen backfill is capable of blending seamlessly into the permafrost. The cost of using cemented rockfill in a 3000 tonnes/day operation can reach $10 million per year just for the cost of the cement alone.

In the frozen backfill delivery system disclosed herein attention must be given to specific details and controls relating to the differences, predominantly temperature measurement and concentrations of the constituents, in the delivery technology. In the long term, frozen backfill is capable of blending seamlessly into the permafrost.

The frozen backfill system disclosed herein comprises waste-rock, tailings, naturally occurring ice and water in specific ratios with attention to the prescribed gradations of the waste-rock and tailings. The tailings, a readily available and very finely divided material, fill the naturally existing voids in the waste-rock. Therefore, the gradation of the waste-rock and the bulk density of the waste-rock establish the rock/tailings ratio, which has been determined to lie between 1 and 3 or from 50/50 to about 75/25. The ice in the mix design arises from the pre-existing moisture content in the rock and tailings typically 2% to 5% for the rock, 8% to 25% for the tailings. The ice content must be controlled for safety reasons, in some cases the tailings can contain excess amounts of water and may have be dewatered prior to using in the frozen backfill, such that the total ice content of the placed frozen backfill not exceed about 15% including that as a result of the addition of the water as a binder.

The latent heat of fusion of water, the 334 J/g of energy released while the water changes state from liquid to solid, is a variable of significant concern in terms of the set time for the frozen backfill. When sufficient latent heat has not been removed from the frozen backfill prior to placement, a delay in the set time occurs and the equilibrium temperature of the frozen backfill is moderated to be at or near zero until the latent heat is exhausted from the frozen backfill. The change of state of liquid water to ice on the particle surfaces is the binding mechanism of the system and also the source of the set time delay.

In order to cause the solid constituents to be bound together by the water setting into ice, vigorous mixing of the water onto the surfaces of the solid materials is required, i.e., the constituents must be fully wetted. The mixing in the proposed method is accomplished by a combination of wide angle spray jets under sufficient pressure to wet deeply into the materials as they fall freely. Mechanical mixing can be achieved by a gravity-driven baffle system, rotating baffles, such as an autogenous grinder, or nested conveyance systems.

The latent heat that is contained in the water is a critical parameter in the process. The overall heat balance and thermal equilibrium temperature depends on the initial temperatures of the materials and the latent heat contained in the water. The specific heat capacity of all materials is a required parameter which must be measured, using a simple calorimeter, for each new mine site as part of the quality control system. For comparison, the heat released during a drop of one degree Celsius of the water temperature is 4.186 J/g, for typical waste-rock 0.8 J/g, tailings 0.9 J/g and the specific heat capacity of ice, cₗ, depends on the temperature as the following linear relationship cₗ=0.007535×T+2.05114.

The delay in reaching the thermodynamic equilibrium temperature is influenced by the thermal conductivity of the system on an internal basis, which depends on the surface transfer of heat between the rock and the tailings/water matrix. Some typical thermodynamic properties are listed in Table 1; however, it must be emphasized that these properties change as a function of temperature, state and mix design. Once the frozen backfill composite formulation has set, i.e., reached the thermodynamic equilibrium temperature, the individual physical properties of the constituents merge to become the thermodynamic property of the frozen backfill.

The goal here is to minimize the time taken for the frozen backfill to reach a strength sufficient to support the mine design specifications, usually in the neighbourhood of at least one mega-pascal (MPa). In order to do so, the initial temperatures, specific heat capacities and mass of the individual constituents are balanced such that the thermodynamic equilibrium temperature of the final mix-design is less than zero degrees Celsius. An example is shown in Table 1, where the specific heat capacities, mass, and temperatures of the constituents are typical values and used to arrive at the thermodynamic equilibrium temperature of less than zero.

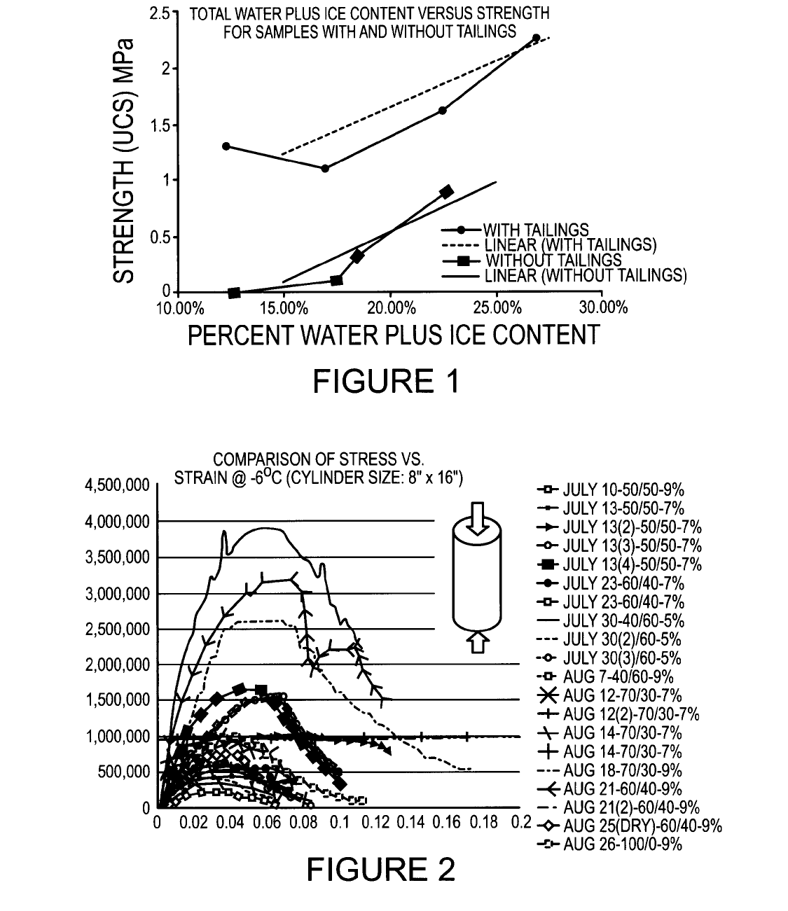

The results of FIG. 1 illustrates the increase in strength when tailings are added to the backfill. The results of tests with tailings, rock and liquid water, with or without adding any snow, show that the addition of the snow had little or no effect on the strength of the sample. A regression plot using the data from all five samples involving rock, water and tailings is shown in FIG. 2. The data are individual sample tests and the regression line treats all data points as though they were taken in a single test. In this way the variation in sample strength data forms the statistical error limits for this phase of testing. At a strain of 0.06 the average strength of five samples is 1.3±0.3 MPa.

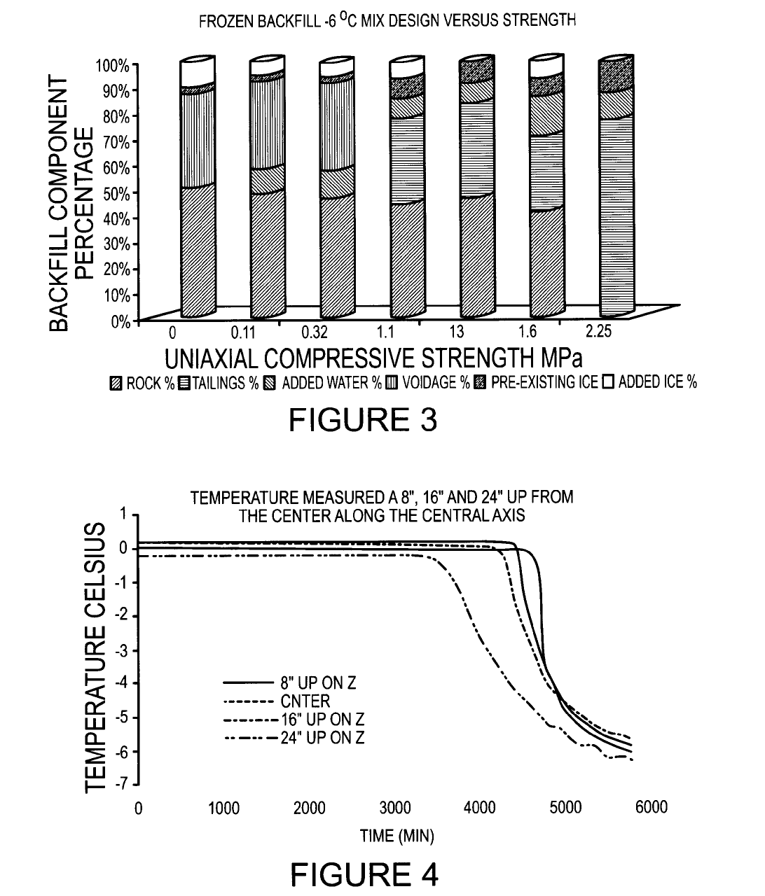

In FIG. 3 the mix design as a weight percentage versus the strength at −6° C. shows that without water the strength does not develop and that as the amount of tailings is increased the strength increases to certain a point.

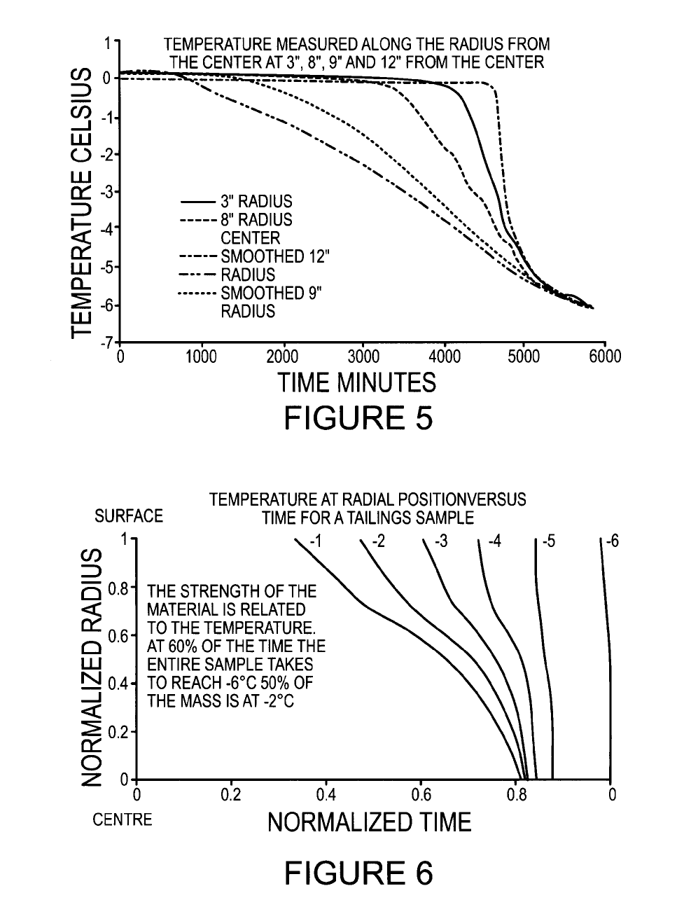

The time required for the backfill to freeze FIGS. 4 and 5 depends on the geometrical properties of the stope, such as size and shape and the thermal properties of the backfill. The thermal properties such as the specific heat capacity and thermal conductivity are slightly more elusive because the backfill is a complex mix with properties that vary as the mass freezes.

The specific heat capacity of the frozen backfill mix is near 1 J/(g° C.) after freezing; however, due to the effect of latent heat, the apparent specific heat capacity of the backfill prior to freezing increases as the percentage of liquid water added increases. Calculating the change in enthalpy for a typical mix the apparent specific heat capacity ΔH/ΔT=3.47 J/(g° C.) was found for the backfill mix design containing rock, tailings, ice and water.

FIGS. 4 and 5 illustrate the temperature versus time, for the tailings and water mix, along the central axis at 20 cm intervals and at mid height along the radius at 7.5 cm intervals respectively. The freezing is delayed internally for the measurements taken along the central axis. The effect of the latent heat of water, seen in the long delay for the onset of freezing. In FIG. 6, the normalized radius of the cylindrical sample versus the normalized time to cool to −6° C., shows how the temperature profile inside the sample may be exploited to determine the time that enough of the backfill is frozen to be stable. After the majority of latent heat has been removed a frozen front moves toward the center of the sample.

The latent heat contained in the water delays the freezing of the backfill material providing some buffer time for the process of filling the stope. The thermodynamic properties of frozen backfill needed in order to facilitate the modelling of future placements are; the specific heat capacity of all materials, the apparent specific heat capacity prior to the removal of latent heat, the final heat capacity after freezing, the thermal conductivity of all materials, the thermal conductivity and the diffusivity of the backfill.

The backfill equilibrium temperature shortly after placement is affected significantly by the amount of water added to the backfill, highly sensitive to the initial temperatures of the cold constituents and marginally sensitive to the initial temperature of the water.

TABLE 1
Thermodynamic equilibrium model
Thermal Equilibrium Model for Frozen Fill Moisture content of solids
Moisture content

| | |
|---|---|
| Rock | 3.80% |
| Tailings | 10.00% |

| | Specific | | | | | |
|---|---|---|---|---|---|---|
| | heat | Measured | Corrected | Initial | | |
| | capacity | Mass | Mass | Temperature | Latent Heat | Percentage |
| Constituent | J/gK | Kg | Kg | ° C. | J/g | mix |
| ROCK | 0.8 | 60 | 57.72 | −20 | | 54.87% |
| Tailings | 0.9 | 40 | 36 | −20 | | 34.22% |
| Ice | 1.90 | 0 | 6.28 | −20 | | 5.97% |
| Water | 4.186 | 5.2 | 5.2 | 1 | 333.15 | 4.94% |
| | | | | | total ice | 10.91% |
| Total | | 105.2 | 105.2 | | | 100.00% |

| | | |
|---|---|---|
| Latent heat factor | 100.00% | Contained |
| FINAL | 272.6606 | Kelvin |
| TEMPERATURE | | |
| FINAL | −0.49937 | Celsius |
| TEMPERATURE | | |
| | 0.00% | Removed |

The methods of causing this thermodynamic balance are to remove latent heat from the water by cooling to temperatures near 0° C. or causing a high pressure spray to nebulize the water or cooling the waste-rock and/or tailings to temperatures sufficient to offset the heat added by the water as determined by the computer control program written for this purpose.

The mix-design is governed by the properties of the waste-rock and tailings in that the voidage of the waste-rock must be filled by the tailings. This leads to a range of values for the constituents as is shown below in weight percent. Also it has been found through uniaxial compressive strength testing on 0.6 m by 1.2 m cylindrical samples that an over abundance of tailings in the mix leads to an overly ductile composite having less stiffness than that required to maintain the structural integrity upon placement. Therefore the amount of tailings added to the mix is tailored to fill the naturally existing voidage on a volumetric basis within the waste rock with the intent that the rock particles would have, in general, an opportunity to make contact causing the stiffness and strength to be greater than that which would be found when the rock particles are distributed throughout the frozen backfill without internal contact. A similar strategy is employed with the addition of aggregate in a typical concrete mix.

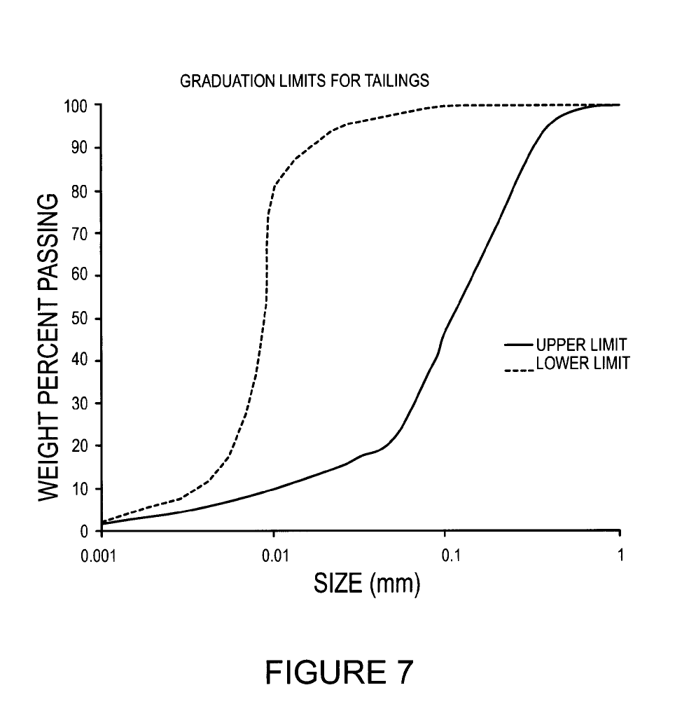

In addition, the mean size of the powdered tailings and crushed rock is important. FIG. 7 shows a plot of weight % versus mean size showing the upper and lower gradation limits for the preferred mean size of the powdered tailings used in the back fill formulations according to the present invention.

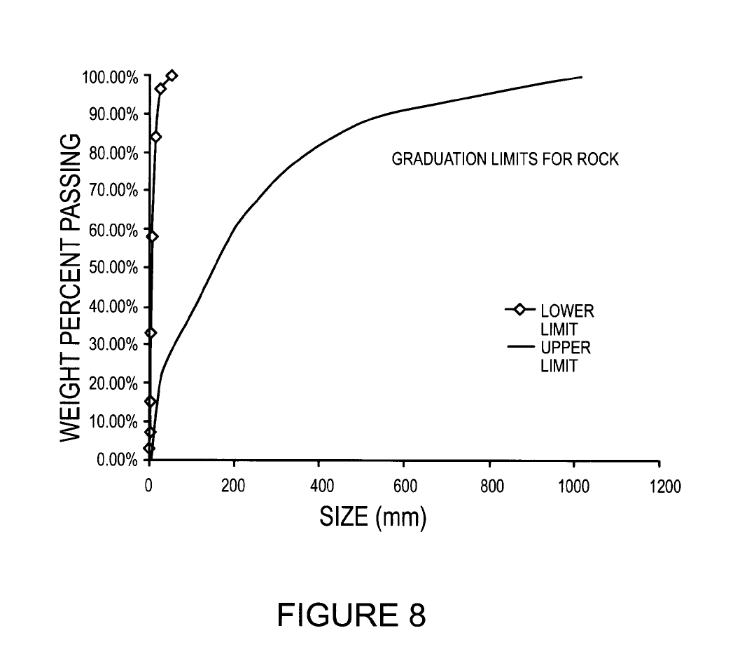

FIG. 8 shows a plot of weight % versus mean size showing the upper and lower gradation limits for the preferred mean size of the crushed rock used in the back fill formulations according to the present invention.

The size range of the rock and tailings, in the mixture, controls the voids ratio of the mixture, the strength and the equilibrium temperature of the backfill mix. The size range of the rock and the naturally occurring voids therein are one determining factor as to the amount of tailings added to the mix. The tailings must fill that voidage but an extra amount over and above that which fill the voids within the rock can be included with the mixture, in general, being mostly comprised of rock. The rock fill acts as a heat sink, adds strength and it is desired to use as large a size as practicle with the intent to avoid the well know segregation effects that are often encountered in backfill operations. The preferred sizes for the tailings lie between 0.01 mm and 0.1 mm and for the rock fill between 50 mm and 1000 mm.

### Rock: 50 wt % to 75 wt %

### Tailings: 25 wt % to 50 wt %

Water: not less than 5 wt % and not greater than 9 wt %
Ice (naturally occurring) not greater than 15% including that due to the addition of liquid water.

The best environments for the frozen backfill methods disclosed herein are environments containing permafrost, such as above 60 degree parallel in the north or in the southern hemisphere where permafrost is present, or anywhere where the temperatures can be maintained at subzero, for example in the neighborhood of −2 to −3 Celsius.

The solids may be transported frozen to the stope area. They are then mixed using a conveying or bin or pass system and the solid constituents can be fed by separate mass flow streams as in the case of conveyors or hoppers for continuous feed or mixed on a batch basis. While the constituents are being dumped to the stope, cold water is pressure sprayed on the falling mix with water jets and is controlled by the measured flow mass/time of the solids. The mixture in the stope reaches equilibrium with the solid mass absorbing the remaining latent heat released through the freezing of the sprayed water. The frozen mass has strength high enough to enable application in open stoping or other mining methods requiring backfill. It will appreciated that dry cement can also be added to the tailings or rockfill mixes to accommodate needs in mine areas which have near zero temperatures.

The formulation of the present invention is different from that disclosed in SU1116184 A1 1 VNII Zolota Redkikh Metallov entitled: FILL-UP MIXTURE COMPOSITION, especially regarding the ICE content. The present formulation avoids the high levels of ice content in the backfill on account of the potential for “brittle failure” occurring in the backfilled stope. The reason for this is that tests, undertaken during these studies, showed that a cleavage can occur with the potential for a large portion of the backfill falling, or sliding from the backfilled stope.

Secondly, the ranges do not specify that the fine particles (tailings), for which a gradation chart will be provided, are used to fill the naturally occurring voidage within the rock. The tailings, in combination with the liquid water, bind to the rock to form a solid mass. The rock/tailings act as a heat sink by being cold enough to offset the effect of the heat added with the water. Of special significance is the need to be concerned over the amount of latent heat of fusion contained in the liquid water.

It is noted that the water stays at zero Celsius while changing state from a liquid to a solid. For this to happen there are 80 cal/g or 334 J/g of heat which must be accounted for and offset by the rock/tailings heat capacity. For example the amount of heat to decrease one gram of water from 80° C. to 0° C. is equal to the amount of heat that must be removed from one gram of water to change state from a liquid at zero degrees Celsius to a solid at zero degrees Celsius.

The amount of tailings and rock used are subject to the testing done at the mine, which is a standard practice at a mine regardless of whether they are using a tried and true (hydraulic backfill) or newer (pastefill) method. The tailings fit into the spaces that are naturally occurring in the rock.

In the present invention, the water content in the formulations disclosed herein, are found to be preferably about 5% at a minimum, the amount needed to fully wet the solids. It can not exceed more than 8% to 9%, as it becomes both dangerous, due to the above brittleness issue, and the time delay for the backfill to freeze could extend to years, an unacceptable time-table for a mine to operate upon.

Thus, the preferred formulations for the present formulations include:

rock: 50% to 75% depending on the gradation charts and measurements taken.
tailings: 25% to 50% depending on the gradation charts and measurements taken. Ice: That which is naturally occurring moisture contained in the rock and tailings and must be minimized and in some cases moisture must be removed.
water: 5% to 9% depending on the temperatures of the rock and tailings and the naturally occurring moisture content of the rock and tailings.

It is noted that typical naturally occurring moisture in the rock and tailings is in the neighborhood of 2% to 3% for rock and 8% to 25% for the tailings. Given that, it will be necessary in some cases to minimize the moisture content. The 60% rock with 2.5% moisture and tailings with 10% to 25% moisture content can result in approximately 5% to about 12% in total naturally occurring ice. It is believed that greater than 12% moisture content is too much and in fact the total ice content (including that as a result of the addition of the liquid water) should not exceed about 15%. For example a 60% waste rock containing 3% moisture contributes 1.8% ice to the mix, the 40% tailings at say 15% moisture content contributes 6% ice to the mix resulting in a total naturally occurring ice content of 7.8%. The addition of 5% to 7% water as liquid raises the total ice content of the mix to 12.8% to 14.8% which is believed to be within acceptable limits.

Thus, the present composition avoids high levels of ice above about 7-8% since; based on studies by the inventors, the use of ice at higher levels is unsafe due to the potential for “brittle failure” of the backfill which must be avoided for the safety of the miners at the site.

In addition, the fines component(s), in the present case tailings or in their case clay/sludge is a much higher percentage. In fact, the rock/tailings ratio lies between 1 and 3 which corresponds to a Rock/Tailings=50%/50% to 75%/25%. In essence the present formulation needs the bulk density of the rock and the voidage so it can be filled by the tailings.

The present backfill compositions use less water content than other backfill compositions in order to minimize the “set time” a latent heat effect which could significantly impact on operations. Using too much water also leads to the “brittle character” which needs to be avoided for safety reasons.

In the present process the water is preferably distributed over the entirety of the solids. In the present process, the process of pressure spraying and mixing is very advantageous in order to avoid delays in the “set time” of the frozen mix.

In the process of the present invention a thermodynamic model is used to assess the feasibility of the placement under the conditions found at the time. In other words there are certain combinations of rock/tailings/water and their respective temperatures, as well, an argument on the removal of some percentage of the latent heat from the liquid state water.

In summary, frozen backfill formulations disclosed herein are viable alternatives to the more expensive cemented backfill options currently available to the mining industry for situations where the ground will remain at subzero temperatures at least for the duration of the operations in the area of the placed frozen backfill. The process involves water sprays, temperature monitoring, mass flows, liquid flows and mixing or blending technology during placement.

The raw materials often available in a typical mining operation are suitable for use in the frozen backfill including waste rock, tailings and ice or snow. The time for the frozen backfill to set is heavily dependent on the temperatures and the amount of the solid materials and the water added; therefore, continued monitoring is preferred as the backfill is poured. The mix formulations have some built-in flexibility; however, a solid consolidated backfill needs to be produced when the process is completed and the stope is full. For those reasons it is stipulated that there must be sufficient tailings (or finely divided sandy material) to fill the voidage of the waste rock. The water content should be a minimum 5% but must not exceed the cold sink capacity available from the solid materials.

An appropriate waste-rock to tailings ratio lies between 1 and 3 or 50% rock with 50% tailings to 75% rock with 25% tailings on a percent weight basis. Other inert additives, except for salts, will not adversely affect the frozen backfill unless there is liquid water contained with the additive. Thermodynamic modeling of the frozen backfill as placed can be used to examine the long-term thermal effects or the amount of time it would take for the frozen backfill to freeze when there is excess heat contained in the mix.

While the present invention is useful for producing infill for mine stopes, it will be appreciated that it may also be used for producing structural members, or actual structures in these sub zero environments. For example, the wetted mixture of rock, tailings, water, ice may be flowed into a form work to contain the mixture and after the mixture has frozen in the work form thereby producing the structure/structural member the work form may be removed once the formulation freezes. Alternatively, it could be left in place as a permanent work form.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. A structural formulation for producing structural members in an environment having a year round subzero ground temperature, comprising:
a) crushed rock present in an amount from about 50 wt % to about 75 wt %;
b) powdered tailings present in an amount from about 25 wt % to about 50 wt %;
c) water present in an amount not less than about 5 wt % and not greater than about 9 wt %;
d) ice, a sum of naturally present ice and that due to the addition of liquid water, being present in an amount not greater than 15% including that due to the addition of liquid water; and
e) wherein said structural formulation once frozen exhibits a strength of at least 1 mega Pascal (MPa).

2. The structural formulation according to claim 1 wherein said crushed rock includes rocks of a general size in a range from about 50 mm mean diameter to about 1000 mm diameter.

3. The structural formulation according to claim 1 wherein said powdered tailings include powder particles of a general size in a range from about 0.001 mm mean diameter to about 1 mm diameter.

4. The structural formulation according to claim 1, wherein said crushed rock is present in an amount from about 60 wt % to about 65 wt %.

5. The structural formulation according to claim 1, wherein said powdered tailings is present in an amount from about 35 wt % to about 40 wt %.

6. The structural formulation according to claim 1 wherein said crushed rock is produced from waste rock produced from mining operations at the mine.

7. The structural formulation according to claim 1 wherein said powdered tailings are produced from tailings produced from mining operations at the mine.

8. The structural formulation according to claim 1 for use as a back fill formulation for filling mine stopes at a mine located in said environment having a year round subzero ground temperature.

9. A back fill formulation for filling mine stopes at a mine located in said environment having a year round subzero ground temperature produced using the back fill formulation of claim 1.

10. A method of producing a structural member in an environment having year round subzero ground temperature, comprising the steps of:
vigorously mixing together a formulation including crushed rock present in an amount from about 50 wt % to about 75 wt %, powdered tailings present in an amount from about 25 wt % to about 50 wt %, water present in an amount not less than about 5 wt % and not greater than about 9 wt %, and naturally occurring ice, the sum of naturally present ice and that due to the addition of liquid water, being present in an amount not greater than 15% including that due to the addition of liquid water while flowing the mixture into a form work containing the as deposited formulation, the addition of liquid water being by spraying a mass of the crushed rock mixed with the powdered tailings with cold water jets as the mixture is dumped into the form work, wherein said formulation once frozen exhibits a strength of at least 1 mega Pascal (MPa).

11. The method according to claim 10 wherein the form work containing the structural member is a temporary form work which is removed once the formulation freezes to form the structural member.

12. The method according to claim 10 wherein the form work containing the structural member is a permanent form work.

13. The method according to claim 10, wherein the environment having year round subzero ground temperature is permafrost.

14. The method according to claim 10, wherein the vigorous mixing is achieved by a combination of wide angle spray jets under sufficient pressure to wet deeply into the mixture of crushed rock and powdered tailings as they fall freely, and wherein said vigorous mixing includes mechanical mixing of the mixture of crushed rock and powdered tailings.

15. The method according to claim 14 wherein the mechanical mixing of the mixture of crushed rock and powdered tailings is achieved using any one or combination of gravity-driven baffle system, rotating baffles, and nested conveyance systems.

16. The method according to claim 15 wherein the rotating baffles are part of an autogenous grinder.

17. The method according to claim 10 including measuring a flow rate of the mixture of crushed rock and powdered tailings as it is dumped into the form work and sprayed with cold water, and based on the measured flow rate adjusting the cold water jets to ensure a desired amount of water is mixed with the crushed rock and powdered tailings, wherein a mixture of the crushed rock, powdered tailings, ice and water forms a solid mass in the stope reaches equilibrium with the solid mass absorbing any remaining latent heat released through the freezing of the sprayed water.

18. The method according to claim 10 wherein said crushed rock includes rocks of a general size in a range from about 50 mm mean diameter to about 1000 mm diameter.

19. The method according to claim 10 wherein said powdered tailings include powder particles of a general size in a range from about 0.001 mm mean diameter to about 1 mm diameter.

20. The method according to claim 10 wherein said crushed rock is present in an amount from about 60 wt % to about 65 wt %.

21. The method according to claim 10 wherein said powdered tailings is present in an amount from about 35 wt % to about 40 wt %.

22. The method according to claim 10 for use as a back fill formulation for filling mine stopes at a mine located in said environment having a year round subzero ground temperature.

23. The method according to claim 22 wherein said crushed rock is produced from waste rock produced from mining operations at the mine.

24. The method according to claim 22 wherein said powdered tailings are produced from tailings produced from mining operations at the mine.

25. A structural formulation for producing structural members in an environment having a year round subzero ground temperature, comprising:
a) crushed rock present in an amount from about 50 wt % to about 75 wt %;
b) powdered tailings present in an amount from about 30 wt % to about 50 wt %;
c) water present in an amount not less than about 5 wt % and not greater than about 9 wt %;
d) ice, a sum of naturally present ice and that due to the addition of liquid water, being present in an amount not greater than 15% including that due to the addition of liquid water; and
e) wherein said structural formulation once frozen exhibits a strength of at least 1 mega Pascal (MPa).
